(19) United States
(12) Patent Application Publication
(10) Pub. No.: US 2008/0166493 A1
(43) Pub. Date: Jul. 10, 2008

(54) COATING COMPOSITIONS FOR MARINE APPLICATIONS AND METHODS OF MAKING AND USING THE SAME

(75) Inventors: T. Danny Xiao, Willington, CT (US); Xinqing Ma, Willington, CT (US); Kim Arnold Wynns, Anchorage, AK (US); Meidong Wang, Willington, CT (US); Jinxiang Dai, Storrs Mansfield, CT (US)

Correspondence Address: CANTOR COLBURN, LLP, 20 Church Street, 22nd Floor, Hartford, CT, 06103, US

(73) Assignee: INFRAMAT CORPORATION, Farmington, CT (US)

(21) Appl. No.: 11/971,468

(22) Filed: Jan. 9, 2008

Related U.S. Application Data
(60) Provisional application No. 60/884,040, filed on Jan. 9, 2007.

(51) Int. Cl. C08K 3/22; C08K 3/36; B05D 1/04; B05D 1/02; B05D 1/28

(52) U.S. Cl. 427/447; 524/430; 524/403; 524/413; 524/407; 524/493; 524/589; 524/604; 524/612; 106/286.4; 106/286.5; 106/286.1; 524/588; 427/452; 427/453; 427/427; 427/427.4; 427/428.01; 427/429; 427/487

(57) ABSTRACT

Anti-fouling coating compositions and methods of making and using those compositions are provided. In an embodiment, a coating composition comprises ceramic nanoparticles, wherein the coating composition is capable of inhibiting contaminants from adhering to a solid surface.

### CROSS REFERENCE TO RELATED APPLICATION

This application claims the benefit of U.S. Provisional Patent Application No. 60/884,040 filed Jan. 9, 2007, which is incorporated by reference herein in its entirety.

### BACKGROUND

The present disclosure generally relates to coating compositions, and more particularly to coating compositions for marine applications.

Biofouling is a significant problem on vessel hulls and heat exchangers, resulting in increased fuel consumption and decreased speed/efficiency. Marine ships can lose much energy because of resistance increases from fouled hull surfaces. Marine organisms that attach on the surface can cause this fouling. The marine organisms can incite adhesion to metal surfaces by producing bioadhesives that adhere to the wet substrate and spread upon it. After the adhesives have spread onto the substrate, adhesion can occur as a result of chemical bonding (e.g., dispersive, dipolar, ionic, covalent, etc.), electrostatic interaction, mechanical interlocking, and diffusion (e.g., marine adhesives can induce movement in surface molecules to create ephemeral voids), either singly or in combination.

The current solution to this troublesome problem is to kill the marine organisms using a metal or an organic biocide. In the past, sailors employed poisons as anti-fouling agents to keep the marine organisms off of the hulls of their boats. For example, copper sheathing was first used on British Naval ships in 1779. Most countries have long prohibited the use of some of these poisons, such as arsenic, cadmium, lead, and mercury; however copper- and tin-containing toxins are still being used today.

Current coatings prevent fouling based on eliminating marine organisms using the concept of slow and controlled release of toxins such as organotin. However, these toxic compounds, which are dispersed in water, can result in mutations in some types of sea life and can enter food chains, thereby significantly affecting the ecological behavior of the living environment on this planet. Due to these potential ecological problems, the Marine Environmental Protection Committee (MEPC) of the International Maritime Organization (IMO), a unit of the United Nations, has approved a draft resolution to phase out and eventually prohibit the use of toxic organotin derivatives in anti-fouling paints.

Copper oxide is commonly used as a less toxic alternative additive in anti-fouling coatings. However, it neither works as effective as tin compounds nor solves the environmental problem completely since copper itself is toxic. Application of copper oxide based paints on marine ship hulls has been found to cause accumulation of copper in ocean organisms.

It is therefore desirable to develop nontoxic anti-fouling coatings that effectively reduce biofouling of marine vessels and parts.

### BRIEF SUMMARY

Disclosed herein are anti-fouling coating compositions and methods of making and using those compositions. In an embodiment, a coating composition comprises ceramic nanoparticles, wherein the coating composition is capable of inhibiting contaminants from adhering to a solid surface.

In another embodiment, a method of coating a solid surface comprises contacting the solid surface with a coating composition comprising ceramic nanoparticles to prevent contaminants from adhering to the solid surface.

In yet another embodiment, a method of making a coating composition comprises combining ceramic nanoparticles with a polymer additive.

The above described and other features are exemplified by the following detailed description and attachments.

### DETAILED DESCRIPTION

Anti-fouling coating compositions for use in coating solid surfaces are described herein. As used herein, “anti-fouling” refers to being capable of preventing contaminants, such as bioadhesives produced by marine organisms, from adhering to a surface. The anti-fouling coating compositions are particularly useful for resisting the adherence of such bioadhesives to the outer surfaces of marine vessels and marine vessel components such as a heat exchanger. In exemplary embodiments, the anti-fouling coating compositions can include ceramic nanoparticles, a mixture of ceramic nanoparticles and a polymer additive in dry powder form or in slurry form, or ceramic nanoparticles dispersed in a binder. As used herein, the term “nanoparticle” refers to particles having a dimension (e.g., width or length) of about 1 nanometer to about 5,000 nanometers (nm). In one embodiment, the nanoparticles can have a dimension of about 1 nm to about 500 nm. In an alternative embodiment, the nanoparticles can have a dimension of about 1 nm to about 100 nm.

These coating compositions have the advantage of being nontoxic and therefore environmentally friendly. As used herein, “nontoxic” is taken to mean that a material does not harm marine animals. Also, due to the presence of the nanoparticles, the coating compositions can be applied to a hull of a marine vessel to provide for a smoother surface and reduced friction when the vessel is in motion. As a result of this reduction in friction, the vessel can be operated with more energy efficiency. Furthermore, the coating that is formed is more wear and abrasion resistant than current anti-fouling coatings and thus experiences less damage such as grooves and scratches when the vessel is in motion. Otherwise, the grooves and scratches could serve as sites for marine animal initiation or incubation. The coatings comprising ceramic nanoparticles are therefore more efficient and durable than current anti-fouling coatings.

Examples of suitable ceramic nanoparticles for use in the coating compositions include but are not limited to alumina, titania, ceria, zirconia, yttria, silica, chromia, and combinations comprising at least one of the foregoing compounds. Coating compositions applied by thermal spraying can be composed of only ceramic nanoparticles.

In embodiments in which the coating compositions include a polymer additive mixed with ceramic nanoparticles, the polymer additive can include, for example, an organic polymer, an inorganic polymer, or a combination comprising at least one of the foregoing polymers. Polymers currently being used in painting formulations for marine applications are particularly suitable. Examples of suitable organic polymers include but are not limited to epoxy, polyurethane, an alkyd polymer, or a combination comprising one of the foregoing polymers. Examples of suitable inorganic polymers include but are not limited to a silicon-based polymer, an aluminum-based polymer, a titanium-based polymer, a boron-based polymer, a rare earth metal-based polymer, or a combination comprising at least one of the foregoing polymers. When the coating composition is a dry powder mixture of ceramic nanoparticles and the polymer additive, the amount of nanoparticles present can range from about 10 weight % (wt %) to about 99 wt %, more specifically about 30 wt % to about 70 wt %, based on the total weight of the composition. When the coating composition is a slurry comprising the ceramic nanoparticles and the polymer additive dispersed in a liquid, e.g., water, the amount of nanoparticles present can range from about 10 wt % to about 99 wt %, more specifically about 25 wt % to about 45 wt %, based on the total weight of the composition.

Other additives that can be present in the coating compositions include but are not limited to surfactants, dispersants, pigments such as barium metaborate, binders, fillers such as calcium carbonate and titanium oxide, and combinations comprising at least one of the foregoing additives. Surfactants and dispersants can be present in relatively small amounts, e.g., less than 5 wt % based on the total weight of the composition. Pigments can be present in relatively low amounts, e.g., about 1 wt % to about 10 wt % based on the total weight of the composition.

In another embodiment, the coating composition is a painting formulation that includes an anti-fouling dispersion phase dispersed in an anti-fouling binding phase. The anti-fouling dispersion phase comprises ceramic nanoparticles like those described above, which are nontoxic to marine animals. The binding phase can include, for example, painting formulation binders currently used in marine applications, organic polymer binders, inorganic polymer binders, and combinations comprising at least one of the foregoing binders. By way of example, the amount of ceramic nanoparticles present can range from about 5 wt % to about 70 wt % based on the total weight of the painting formulation; and the amount of binder present can range from about 30 wt % to about 95 wt % based on the total weight of the painting formulation.

Various techniques can be employed to coat a solid surface with the coating compositions described herein and thereby form a coating on that surface. Examples of suitable techniques include thermal spraying, spraying using a hot gun, spraying using a cold gun, brushing, or rolling.

In an embodiment, the coating compositions can serve as a feedstock for a spray gun. The spray gun can be, for example, a thermal spray gun, a hot spray gun, and a cold spray gun. The nanoparticles in the feedstock can be agglomerated together to form a plurality of microparticles having a dimension of about 1 micrometer to about 5,000 micrometers (microns), more specifically about 1 micron to about 500 microns, or even more specifically about 1 micron to about 100 microns.

In one embodiment, thermal spraying can be performed by feeding the coating composition that includes an agglomeration of ceramic nanoparticles in powder form to a flame gun. The flame gun can propel the powder onto the targeted surface. During powder transient from the powder feeding port to the working piece of the flame gun, the powder can be subjected to partial melting or complete melting such that high coating bond strength is achieved. Examples of suitable thermal spray equipment include but are not limited to a high velocity oxy-fuel (HVOF) torch, an oxygen acetylene torch, an arc transfer torch, a plasma, an induction plasma, and any other high energy beams. In some cases, a post grinding can be used to reduce the surface roughness of the resulting coating. Thermal spraying is particularly suitable for coating metal surfaces.

Examples of suitable feedstock powders for thermal spraying include but are not limited to Inframat Corporation's off-the-shelf thermal spray powders of alumina/titania, alumina/titania with ceria and zirconia additives, alumina, and titania. Procedures for making these feedstock powders can be found in U.S. Pat. Nos. 6,025,034 and 6,723,674, which are incorporated by reference herein. Generally, the feedstock powders can be prepared by dispersing the selected ceramic nanoparticles in a liquid such as water, ball milling the resulting mixture to de-agglomerate the particles, and adding a binder and surfactants to the mixture to make a uniform slurry or nanoparticle dispersion. The slurry can then be spray dried to form agglomerated microparticles as powder feedstock, where each microparticle is an assemblage of many individual nanoparticles. The powder feedstock is now ready to be thermal sprayed. Depending on the choice of the final desired properties of the coating, the feedstock can be subjected to post-heat treatment or plasma heating for densification.

In another embodiment, the coating compositions can be sprayed using a hot gun. Low melting temperature polymer particles and ceramic nanoparticles can be agglomerated to form a sprayable powder feedstock. Suitable ceramic powders include the Inframat powders described above. The agglomeration can be formed by dispersing the polymer/ceramic nanoparticles in a liquid such as water for de-agglomeration, adding surfactants to the resulting slurry, and spray drying or granulizing the slurry. The prepared feedstock can then be injected into the hot gun to melt the polymer and spray the feedstock onto the targeted surface. Hot gun spraying is particularly suitable for coating metal and plastic surfaces.

In yet more embodiments, the coating compositions can be sprayed on using a cold spray gun, brushed on, or rolled on the solid surface. These techniques are particularly suitable for coating steel, wood, fiberglass, and plastic surfaces. The coating compositions can be prepared for such applications by dispersing the ceramic nanoparticles in a liquid, e.g., water, comprising the polymer additive to form a dispersion, slurry, or paste. After applying the coating compositions to the solid surface, they can be cured to form a solid coating by furnace heat treatment, thermal ultraviolet (UV) treatment, or aging at room temperature to evaporate the liquid.

Other methods for applying the coating compositions to a solid surface would be apparent to those skilled in the art. For example, they can be deposited via an electrodeposition technique such as electroplating, electroless plating, electrophoretic deposition, or electrobrushing.

In additional exemplary embodiments, nano-composite coating compositions can include ceramic nanoparticles and a silicone polymer such as polydimethylsiloxane (PDMS). The coating compositions can also include one or more crosslinking agents. In a specific embodiment, the coating compositions include ceramic nanoparticles, PDMS, multialkyloxysilane (a crosslinking agent), and 1,3-divinyltetramethyldisiloxane (a crosslinking agent). The PDMS can form a coating with low surface free energy. The multialkyloxysilane can be used as a crosslinking agent to cause the formation of an interpenetrating polymer network that immobilizes groups, resists rearrangement and infiltration of marine bioadhesives, and enhances the coating stability. The 1,3-divinyltetramethldisloxane can further crosslink the PDMS to strengthen the hydrolysis resistance of the system. The polymer network can be free of heteroatoms, ions, and dipoles on the surface. The PDMS polymer can also be modified by copolymerization with vinyltrialkyloxysilane to further avoid the introduction of any polar groups (e.g., polyurethane groups or carbonyl groups) to the PDMS resin. Ceramic nanoparticles can be included in the formed network by chemical interaction between the oxygen atoms of the ceramic oxide nanoparticles and the silicon atoms in the PDMS backbone. By photocatalytic oxidation, ceramic nanoparticles, e.g., titania (TiO₂), can decompose environmental pollutants and bioorganic material. The inclusion of the ceramic nanoparticles in the coating compositions can also improve the hardness and smoothness of the final coating.

The silicone-based coating compositions can be applied to a solid surface by, for example, roll-coating, brushing, dipping, or spraying. Crosslinking of the coating compositions can be accomplished at room temperature with the aid of atmospheric moisture and sunlight. The selection of the crosslinking agent is necessary to obtain a tenacious coating. During curing, copolymerization, and crosslinking of vinyl-terminated PDMS, vinyltrialkyloxysilane and 1,3-divinyltetramethldisloxane will occur under sunlight (see Scheme 1).

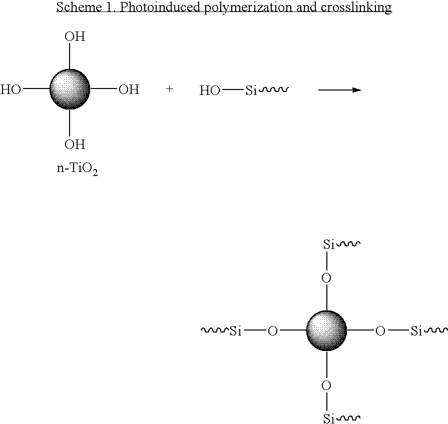

In addition, the formation of the crosslinked matrix can involve the conversion of the alkyloxysilane group into active silanol groups through hydrolysis by atmospheric moisture and condensation reactions (see Scheme 2). The ceramic nanoparticles, also acting as a crosslinker, can be covalently linked to the PDMS polymer by the reaction of hydroxyl groups on the surface of ceramic nanoparticles and active silanol groups (see Scheme 3). The curing process depends on the length of the vinyl-terminated PDMS polymer chains, the molar ratio of the composition, the humidity, the light irradiation, the activity of the curing catalyst, and the temperature.

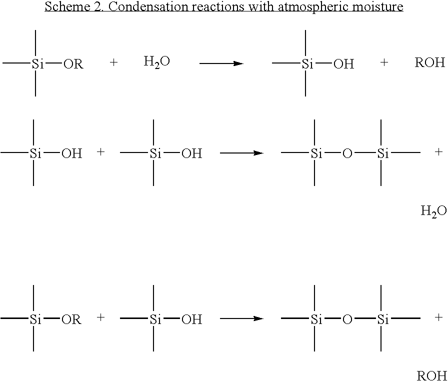

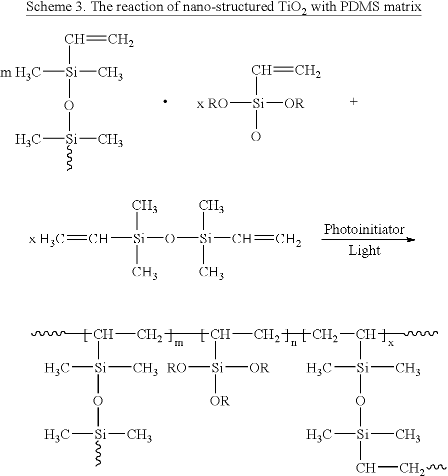

The coating compositions described herein can be utilized as anti-fouling coatings in marine applications. Such coatings are resistant to the adhesion of bioadhesives produced by marine organisms to their surfaces. Other desirable properties of the coating include hardness, corrosion resistance, wear resistance, abrasion resistance, and non-toxic. The coating compositions can also be utilized in architectural (e.g., buildings and bridges), aerospace, automotive, locomotive, petrochemical processing, chemical processing, manufacturing, and mining applications.

### EXAMPLES

The following non-limiting examples further illustrate the various embodiments described herein.

### Example 1

### Thermal Spraying of Alumina (Al₂O₃)/titania (TiO₂)

Nano-grained alumina/titania (Inframat) materials were used as feedstock. An air plasma spray system (9 MB-gun, Sulzer-Metco) was employed to apply a coating to carbon steel substrates using multiple passes. Each substrate was heated up to a temperature above 80° C. in a preheating process. The resultant layers had a density of more than 95% and a normal thickness of 200-250 millimeters (mm). The typical plasma spraying parameters for the materials are given as below:
Plasma gases: Primary gas Ar, 100 pounds per squared inch (PSI), 80 standard cubic foot per hour (SCFH)
   Secondary gas H₂, 50 PSI.
Plasma power: 600 Amperes (A)/65 Volts (V)
Standoff distance: 3 inches
Gun speed: traverse speed of 1000 mm/s; vertical speed of 8 mm/s
Powder feed rate: 3 pounds/hour (lb/hr)

### Example 2

### Thermal Spraying of Al₂O₃/TiO₂+CeO₂+YSZ

Nano-grained alumina/titania (87:13 weight ratio) with addition of 8-10 weight percent (wt %) ZrO₂ and 6-8 wt % CeO₂ (Nanox™ S2613S, Inframat) material was used as feedstock. An air plasma spray system (9 MB-gun, Sulzer-Metco) was employed to apply a coating to carbon steel substrates using multiple passes. Each substrate was heated up to a temperature above 80° C. in a preheating process. The resultant layers had a density of more than 95% and a normal thickness of 200-250 mm. The typical plasma spraying parameters for the material are given as below:
Plasma gases: Primary gas Ar, 100 PSI, 80 SCFH
   Secondary gas H₂, 50 PSI.
Plasma power: 600 A/65 V
Standoff distance: 3 inches
Gun speed: traverse speed of 1000 mm/s; vertical speed of 8 mm/s
Powder feed rate: 3 lb/hr

### Example 3

### Thermal Spraying of Al₂O₃

Commercial alumina (Sulzer-Metco) and nano-grained alumina (Infrox™ S2601) materials were used as feedstock. An air plasma spray system (9 MB-gun, Sulzer-Metco) was employed to apply a coating to carbon steel substrates using multiple passes. Each substrate was heated up to a temperature above 80° C. in a preheating process. The resultant layers had a density of more than 95% and a normal thickness 200-250 mm. The typical plasma spraying parameters for the materials are given as below:
Plasma gases: Primary gas Ar, 100 PSI, 100 SCFH
   Secondary gas H₂, 50 PSI.
Plasma power: 600 A/70 V
Standoff distance: 3 inches
Gun speed: traverse speed of 1000 mm/s; vertical speed of 8 mm/s
Powder feed rate: 2.5 lb/hr

### Example 4

### Thermal Spraying of ZrO₂/Y₂O₃

Commercial ZrO₂-8 wt % Y₂O₃ (204NS, Sulzer-Metco) and nano-grained ZrO₂-7 wt % Y₂O₃ (Nanox™ S4007, Inframat) materials were used as feedstock. An air plasma spray system (9 MB-gun, Sulzer-Metco) was employed to apply a coating to carbon steel substrates using multiple passes. Each substrate was heated up to a temperature above 100° C. in a preheating process. The resultant layers had a density of more than 85% and a normal thickness of 200-250 mm. The typical plasma spraying parameters for the materials are given as below:
Plasma gases: Primary gas Ar, 100 PSI, 80 SCFH
   Secondary gas H₂, 50 PSI.
Plasma power: 600 A/65 V
Standoff distance: 4 inches
Gun speed: traverse speed of 1000 mm/s; vertical speed of 8 nm i/s
Powder feed rate: 4 lb/hr

### Example 5

### Thermal Spraying of Cr₂O₃

Commercial chromium oxide (136, Sulzer-Metco) and nano-grained chromium oxide (Nanox™ S2400, Inframat) materials were used as feedstock. An air plasma spray system (9 MB-gun, Sulzer-Metco) was employed to apply a coating to carbon steel substrates using multiple passes. Each substrate was heated up to a temperature above 100° C. in a preheating process. The resultant layers had a density of more than 95% and a normal thickness 200-250 mm. The typical plasma spraying parameters for the materials are given as below:
Plasma gases: Primary gas Ar, 100 PSI, 80 SCFH
   Secondary gas H2, 50 PSI.
Plasma power: 600 A/70 V
Standoff distance: 2.5 inches
Gun speed: traverse speed, 1000 mm/s; vertical speed, 8 mm/s
Powder feed rate: 3 lb/hr

### Example 6

### Thermal Spraying of Mixture of Al₂O₃/TiO₂ and ZrO₂/Y₂O₃

The mixture of nano-grained Al₂O₃-13 wt % TiO₂ (Nanox™ S2613S, Inframat) and ZrO₂-7 wt % Y₂O₃ (Nanox™ S4007, Inframat) was prepared by mechanically blending the two feedstock materials. An air plasma spray system (9 MB-gun, Sulzer-Metco) was employed to apply a coating to carbon steel substrates using multiple passes. Each substrate was heated up to a temperature above 100° C. in a preheating process. The resultant layers had a density of more than 85% and a normal thickness of 200-250 mm. The typical plasma spraying parameters for the materials are given as below:
Plasma gases: Primary gas Ar, 100 PSI, 80 SCFH
   Secondary gas 1H2, 50 PSI.
Plasma power: 600 A/70 V
Standoff distance: 3.5 inches
Gun speed: traverse speed of 1000 mm/s; vertical speed of 8 mm/s
Powder feed rate: 3.5 lb/hr

### Example 7

### Thermal Spraying of a Mixture of Polyamide and Al₂O₃/TiO₂

Nano-grained Al₂O₃-13 wt % TiO₂ materials were used as feedstock additive to a commercial grade polyamide powder graded between 80 micron and 120 micron. The volume percent of the nano-grained alumina/titania powder that was added to the dry blend of polyamide powder ranged from 30% to 70% by total volume of the mixture. A commercial grade powder combustion gun was employed to apply a coating to carbon steel, wood, and composition fiberglass substrates. Each substrate was heated up to a temperature above 80° C. in a preheating process. The dry blend of powders was sprayed with a fuel gas/oxygen flame onto the substrates using multiple passes. The resultant layers had a density of more than 99% and a normal thickness of 100-500 mm. The typical powder combustion spray gun parameters for the materials are given as below:
Combustion gases:
   Primary Gas: Compressed Air, 45 PSI, 50 SCFH
   Fuel Gas: Propane, 25 PSI.
   Combustion Gas: Oxygen, 21 PSI
   Powder Air: Compressed Air, 24 PSI
Standoff distance: 75 to 150 mm
Gun speed: traverse speed of 152 mm/s
Powder feed rate: 163 lb/hr

### Example 8

### Thermal Spraying of a Mixture of Nylon 11 and Al₂O₃/TiO₂

Nano-grained Al₂O₃-13 wt % TiO₂ materials were used as feedstock additive to a commercial grade Nylon 11 polyamide powder. The polyamide powder was graded between 80 micron and 120 micron. The volume percent of the nano-grained alumina/titania powder that was added to the dry blend of polyamide powder ranged from 30% to 70% by total volume of the mixture. A commercial grade powder combustion gun was employed to apply a coating to carbon steel, wood, and composition fiberglass substrates. Each substrate was heated up to a temperature above 80° C. in a preheating process. The dry blend of powders was sprayed with a fuel gas/oxygen flame onto the substrates using multiple passes. The resultant layers had a density of more than 99% and a normal thickness of 100-500 mm. The typical powder combustion spray gun parameters for the materials are given as below:
Combustion gases:
   Primary Gas: Compressed Air, 45 PSI, 50 SCFH
   Fuel Gas: Propane, 25 PSI.
   Combustion Gas: Oxygen, 21 PSI
   Powder Air: Compressed Air, 24 PSI
Standoff distance: 75 to 150 mm
Gun speed: traverse speed, 152 mm/s
Powder feed rate: 163 lb/hr

### Example 9

### Thermal Spraying of a Mixture of Polyamide, Al₂O₃/13TiO₂, ZrO₂/7Y₂O₃, CeO₂, and Cr₂O₃

Nano-grained Al₂O₃-13 wt % TiO₂, yttria stabilized zirconia (ZrO₂-7 wt % Y₂O₃), CeO₂, and Cr₂O₃ materials were used as feedstock additive to a commercial grade polyamide powder graded between 80 micron and 120 micron. Equal amounts of nano-grained alumina/titania, yttria stabilized zirconia, chromia, and ceria were added to the dry blend of powders at a volume percentage ranging from 30% to 70% by total volume of the mixture. A commercial grade powder combustion gun was employed to apply a coating to carbon steel, wood and composition fiberglass substrates. Each substrate was heated up to a temperature above 80° C. in a preheating process. The dry blend of powders was sprayed with a fuel gas/oxygen flame onto the substrates using multiple passes. The resultant layers had a density of more than 99% and a normal thickness of 100-500 mm. The typical powder combustion spray gun parameters for the materials are given as below:
Combustion gases:
   Primary Gas: Compressed Air, 45 PSI, 50 SCFH
   Fuel Gas: Propane, 25 PSI.
   Combustion Gas: Oxygen, 21 PSI
   Powder Air: Compressed Air, 24 PSI
Standoff distance: 75 to 150 min
Gun speed: traverse speed of 152 mm/s
Powder feed rate: 163 lb/hr

### Example 10

### Thermal Spraying of a Mixture of Polyamide and ZrO₂

Nano-grained ZrO₂ material was used as feedstock additive to a commercial grade polyamide powder. The polyamide powder was graded between 80 micron and 120 micron. The volume percent of the nano-grained zirconia powder that was added to the dry blend of polyamide powder ranged from 30% to 70% by total volume of the mixture. A commercial grade powder combustion gun was employed to apply a coating to carbon steel, wood, and composition fiberglass substrates. Each substrate was heated up to a temperature above 80° C. in a preheating process. The dry blend of powders was sprayed with a fuel gas/oxygen flame onto the substrates using multiple passes. The resultant layers have a density of more than 99% and a normal thickness of 100-500 mm. The typical powder combustion spray gun parameters for the materials are given as below:
Combustion gases:
   Primary Gas: Compressed Air, 45 PSI, 50 SCFH
   Fuel Gas: Propane, 25 PSI.
   Combustion Gas: Oxygen, 21 PSI
   Powder Air: Compressed Air, 24 PSI
Standoff distance: 75 to 150 mm
Gun speed: traverse speed of 152 mm/s
Powder feed rate: 163 lb/hr

### Example 11

### Thermal Spraying of a Mixture of Polyamide and Cr₂O₃

Nano-grained Cr₂O₃ material was used as feedstock additive to a commercial grade polyamide powder. The polyamide powder was graded between 80 micron and 120 micron. The volume percent of the nano-grained chromia powder that was added to the dry blend of polyamide powder ranged from 30% to 70% by total volume of the mixture. A commercial grade powder combustion gun was employed to apply a coating to carbon steel, wood, and composition fiberglass substrates. Each substrate was heated up to a temperature above 80° C. in a preheating process. The dry blend of powders was sprayed with a fuel gas/oxygen flame onto the substrates using multiple passes. The resultant layers had a density of more than 99% and a normal thickness of 100-500 mm. The typical powder combustion spray gun parameters for the materials are given as below:
Combustion gases:
   Primary Gas: Compressed Air, 45 PSI, 50 SCFH
   Fuel Gas: Propane, 25 PSI.
   Combustion Gas: Oxygen, 21 PSI
   Powder Air: Compressed Air, 24 PSI
Standoff distance: 75 to 150 mm
Gun speed: traverse speed of 152 mm/s
Powder feed rate: 163 lb/hr

### Example 12

### Thermal Spraying of a Mixture of Polyamide and Al₂O₃

Nano-grained Al₂O₃ material was used as feedstock additive to a commercial grade polyamide powder. The polyamide powder was graded between 80 micron and 120 micron. The volume percent of the nano-grained alumina powder that was added to the dry blend of polyamide powder ranged from 30% to 70% by total volume of the mixture. A commercial grade powder combustion gun was employed to apply a coating to carbon steel, wood, and composition fiberglass substrates. Each substrate was heated up to a temperature above 80° C. in a preheating process. The dry blend of powders was sprayed with a fuel gas/oxygen flame onto the substrates using multiple passes. The resultant layers had a density of more than 99% and a normal thickness of 100-500 mm. The typical powder combustion spray gun parameters for the materials are given as below:
Combustion gases:
   Primary Gas: Compressed Air, 45 PSI, 50 SCFH
   Fuel Gas: Propane, 25 PSI.
   Combustion Gas: Oxygen, 21 PSI
   Powder Air: Compressed Air, 24 PSI
Standoff distance: 75 to 150 mm
Gun speed: traverse speed of 152 mm/s
Powder feed rate: 163 lb/hr

### Example 13

### Thermal Spraying of a Mixture of Polyamide and TiO₂

Nano-grained TiO₂ material was used as feedstock additive to a commercial grade polyamide powder. The polyamide powder was graded between 80 micron and 120 micron. The volume percent of the nano-grained titania powder that was added to the dry blend of polyamide powder ranged from 30% to 70% by total volume of the mixture. A commercial grade powder combustion gun was employed to apply a coating to carbon steel, wood, and composition fiberglass substrates. Each substrate was heated up to a temperature above 80° C. in a preheating process. The dry blend of powders was sprayed with a fuel gas/oxygen flame onto the substrates using multiple passes. The resultant layers had a density of more than 99% and a normal thickness of 100-500 mm. The typical powder combustion spray gun parameters for the materials are given as below:
Combustion gases:
   Primary Gas: Compressed Air, 45 PSI, 50 SCFH
   Fuel Gas: Propane, 25 PSI.
   Combustion Gas: Oxygen, 21 PSI
   Powder Air: Compressed Air, 24 PSI
Standoff distance: 75 to 150 mm
Gun speed: traverse speed of 152 mm/s
Powder feed rate: 163 lb/hr

### Example 14

### Coating Substrate with Urethane-Based Material Comprising Al₂O₃

A two component urethane-based coating was blended with nanoparticles of Al₂O₃ to form a coating for steel, wood, or fiberglass substrates. The nanoparticles were mixed with a solvent using a high speed mixer to break up the nanoparticles from the agglomerated feed stock. The nanoparticles were then blended with the urethane resin or the activator to allow for homogeneous mixing and uniform distribution of the nanoparticles. The nanoparticle loaded urethane resin or activator were thereafter mixed together and applied by spray, roller, or brushing on to each substrate. The urethane was allowed to cure, leaving an enhanced coating and improved surface properties. Since urethanes are normally 100 wt % solids, a 5 wt % to 80 wt % loading of alumina nanoparticles can be achieved. Curing time was about one day.

### Example 15

### Coating Substrate with Urethane-Based Material Comprising Al₂O₃/TiO₂

A two component urethane-based coating was blended with nanoparticles of Al₂O₃/TiO₂ to form a coating for steel, wood, or fiberglass substrates. The nanoparticles were mixed with a solvent using a high speed mixer to break up the nanoparticles from the agglomerated feed stock. The nanoparticles were then blended with the urethane resin or the activator to allow for homogeneous mixing and uniform distribution of the nanoparticles. The nanoparticle loaded urethane resin or activator was thereafter mixed together and applied by spray, roller or, brushing on to the substrate. The urethane was allowed to cure, leaving an enhanced coating and improved surface properties. Since urethanes are normally 100 wt % solids, a 5 wt % to 80 wt % loading of nanoparticles can be achieved. Curing time was about one day.

### Example 16

### Coating Substrate with Urethane-Based Material Comprising Al₂O₃/TiO₂/CeO₂/Y₂O₃/ZrO₂

A two component urethane-based coating was blended with nanoparticles of Al₂O₃/TiO₂/CeO₂/Y₂O₃/ZrO₂ (87 grams Al₂O₃, 13 grams TiO₂, 6 grams CeO₂, 10 grams 7YSZ (7 wt % Y₂O₃+93 wt % ZrO₂) to form a coating for steel, wood, or fiberglass substrates. The nanoparticles were mixed with a solvent using a high speed mixer to break up the nanoparticles from the agglomerated feed stock. The nanoparticles were then blended with the urethane resin or the activator to allow for homogeneous mixing and uniform distribution of the nanoparticles. The nanoparticle loaded urethane resin or activator was thereafter mixed together and applied by spray, roller or, brushing on to the substrate. The urethane was allowed to cure, leaving an enhanced coating and improved surface properties. Since urethanes are normally 100 wt % solids, a 5 wt % to 80 wt % loading of nanoparticles can be achieved. Curing time was about one day.

### Example 17

### Coating Substrates with Urethane-Based Material Comprising TiO₂

A two component urethane-based coating was blended with nanoparticles of TiO₂ to form a coating for steel, wood, or fiberglass substrates. The nanoparticles were mixed with a solvent using a high speed mixer to break up the nanoparticles from the agglomerated feed stock. The nanoparticles were then blended with the urethane resin or the activator to allow for homogeneous mixing and uniform distribution of the nanoparticles. The nanoparticle loaded urethane resin or activator was thereafter mixed together and applied by spray, roller or, brushing on to the substrate. The urethane was allowed to cure, leaving an enhanced coating and improved surface properties. Since urethanes are normally 100 wt % solids, a 5 wt % to 80 wt % loading of nanoparticles can be achieved. Curing time was about one day.

### Example 18

### Testing of the Anti-Fouling Coatings in Marine Environments

A gel-coat fiberglass substrate like that currently used for marine boat hull construction was coated with a polyamide blend of nanoparticles and with a urethane, fluorolatic resin loaded with nanoparticles. The sample was coated on one side of a nominally 6-inch square flat panel. This sample along with uncoated samples were immersed into sea water near boat docks on the Atlantic ocean. The water temperature measured 74° F., and the samples were exposed to rise and drop of the tides, allowing partial immersion at low tide.

The uncoated samples had barnacles and sea grass growing on the surface within two weeks while the coated surfaces had no barnacles or sea grass growing on the surface after eight months.

### Example 19

### Testing of the Anti-Fouling Coatings in Marine Environments

A urethane-based coating for extreme condition that is commercially available from Lauren Coatings as FLUOROLAST and Nylon 11 was used to form different compositions with different loadings. The nanoparticles that were used were alumina, titania, and two different alumina-titania blends (13 wt % and 7 wt % titania). The loadings were 10, 20, 30, and 40 wt %. A loading of less than 10 wt % was not considered as earlier experiments indicated that a loading of at least 10 wt % is preferred. A simple hand paddle was used to hand blend the compositions. Also, barium metaborate monohydrate, a pigment, was added to two side samples in an attempt to influence the “anti-microbial” chemical exchange. Only one nanoparticle size loading was used for these samples (30 wt % alumina, 10 wt % barium metaborate). Barium metaborate monohydrate is commercially available, stable, low cost, and easily blended with the nanoparticles.

Samples of fiberglass from an old, weathered boat hull were cut into squares/rectangles of about 6″ to 8″ and coated on both sides with the various coating compositions after minimal surface preparation. The surface preparation involved either an aggressive high pressure water blast or a careful abrasive blasting. Recycled glass was used in the −40, +70 mesh and the −60, +100 mesh blasting media size. These finer sizes tend to be more forgiving in not destroying the fiberglass gel-coat. All samples were placed at the edge of a boat dock where they could be easily accessed. The boat dock was on the protected side of the inlet and thus did not come into contact with direct sea conditions. However, the boat dock came into contact with each and every tide (low/high) such that the samples were exposed to changing sea conditions and water levels. During testing, the samples were static and were exposed from time to time to air with a variable water line.

The 10% and the 20% nanopower loadings showed low resistance to the attachment of barnacles; however, the 30% and the 40% loadings showed good resistance to the attachment of barnacles. In all cases, silt seemed to still attach to the surface where sea grass could start growing. The barium metaborate sample looked different than the other samples.

The samples were held in the water for a period of 6 months off and on. Visual examination of the painted surfaces revealed similar results for all three coatings with 30% and 40% particle loadings. It appeared that the coating started to wear down around the particles and the surface became rougher over time because the barnacles were able to eat away (chemically react with) the coating chemistry. The FLUOROLAST coating seemed to do the best, probably due to the F compounds present therein. The Nylon coatings and the paint formulations had sea grass growing on the surface that was easily removed using a hand wiping motion, which suggests that if the coatings were applied to a boat hull traveling at a decent velocity, nothing would attach to the coatings.

### Example 20

### Making Painting Formulations Comprising a Silicon-Based Polymer

To prepare a paint formulation, a vinyl-terminated PDMS, which can be synthesized by the reaction of commercial hydroxyl-terminated PDMS with dimethylvinylchlorosilane, was obtained to take part in the crosslinking reaction. The vinyl groups in the PDMS polymer can copolymerize with vinyltrialkyloxysilane, introduce multi-active groups on PDMS, and also take part in a cross-linking reaction with 1,3-divinyltetramethyldisiloxane via free radical polymerization using a photoinitiator. Next, a TiO₂ nanoparticle colloidal solution was prepared and mixed with the PDMS polymer. The procedure for preparing the TiO₂ nanoparticle colloidal solution using a mechanical approach was as follows: (1) disperse 100 grams (g). TiO₂ nanoparticles in 1000 milliliters (mL) of ethanol with an ultrasonic stir, (2) add suitable surfactants, and (3) de-agglomerate the mixture by an attrition milling technique

Subsequently, the TiO₂-PDMS nanocomposite formulation was prepared by mixing the PDMS polymer with the TiO₂-ethanol nanoparticle colloid solution. The detailed procedure was: (1) dissolve 200-300 g modified PDMS polymer into a 1000 ml, TiO₂ nanoparticle colloidal solution, (2) add vinyltrimethoxysilane, 1,3-divinyltetramethldisloxane, and additional additives into the mixture solution, (3) add photoinitiator and curing catalyst to the mixture, and (4) seal composite in a sealed container.

### Example 21

### Preparing Coatings Using a Nanocomposite Painting Formulation

The experimental procedure was as follows: (1) prepare a stainless steel plate and clean the surface, (2) add a cross-linking agent to the TiO₂-PDMS nanocomposite formulation, (3) paint the mixture formulation on the stainless steel plate using a brush technique, and (4) place the paint stainless steel plate under the sun to dry for ˜1 day.

As used herein, the terms “a” and “an” do not denote a limitation of quantity, but rather denote the presence of at least one of the referenced item. Moreover, the endpoints of all ranges directed to the same component or property are inclusive of the endpoints and are independently combinable (e.g., “about 5 wt % to about 20 wt %,” is inclusive of the endpoints 5 and 20 and all values between 5 and 20). Reference throughout the specification to “one embodiment”, “another embodiment”, “an embodiment”, and so forth means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments. Unless defined otherwise, technical and scientific terms used herein have the same meaning as is commonly understood by one of skill in the art to which this invention belongs.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

1. A coating composition comprising: ceramic nanoparticles, wherein the coating composition is capable of inhibiting contaminants from adhering to a solid surface.

2. The coating composition of claim 1, wherein the ceramic nanoparticles comprise alumina, titania, ceria, zirconia, yttria, silica, chromia, or a combination comprising at least one of the foregoing compounds.

3. The coating composition of claim 1, wherein the ceramic nanoparticles have a dimension of about 1 nanometer to about 5,000 nanometers.

4. The coating composition of claim 1, wherein the ceramic nanoparticles have a dimension of about 1 nanometer to about 500 nanometers.

5. The coating composition of claim 1, further comprising an organic polymer, an inorganic polymer, or a combination comprising at least one of the foregoing polymers.

6. The coating composition of claim 5, wherein the organic polymer comprises epoxy, polyurethane, an alkyd polymer, or a combination comprising one of the foregoing polymers.

7. The coating composition of claim 5, wherein the inorganic polymer comprises a silicon-based polymer, an aluminum-based polymer, a titanium-based polymer, a boron-based polymer, a rare earth metal-based polymer, or a combination comprising at least one of the foregoing polymers.

8. The coating composition of claim 1, wherein the coating composition is a feedstock for a spray gun.

9. The coating composition of claim 8, wherein the feedstock comprises an agglomeration of the ceramic nanoparticles, the agglomeration having a dimension of about 1 micrometer to about 500 micrometers.

10. The coating composition of claim 1. further comprising a liquid in which the ceramic nanoparticles are dispersed and a polymer additive.

11. The coating composition of claim 1, further comprising a silicone polymer and a crosslinking agent.

12. The coating composition of claim 1, further comprising polydimethylsiloxane, multialkyloxysilane, and 1,3-divinyltetramethyldisiloxane.

13. The coating composition of claim 12, wherein the polydimethylsiloxane is copolymerized with vinyltrialkyloxysilane.

14. The coating composition of claim 1, wherein the coating composition is a painting formulation comprising:
an anti-fouling dispersion phase comprising the ceramic nanoparticles and being nontoxic to marine animals; and
an anti-fouling binding phase in which the dispersion phase is dispersed.

15. The coating composition of claim 14, wherein the anti-fouling binding phase comprises an organic polymer binder, an inorganic polymer binder, or a combination comprising at least one of the foregoing binders.

16. A coating made by a method comprising: applying the painting formulation of claim 14 to a solid surface.

17. The coating of claim 16, wherein said applying comprises thermal spraying, spraying using a hot gun, spraying using a cold gun, brushing, or rolling.

18. A method of coating a solid surface, comprising: contacting the solid surface with a coating composition comprising ceramic nanoparticles to prevent contaminants from adhering to the solid surface.

19. The method of claim 18, wherein said contacting comprises thermal spraying, spraying using a hot gun, spraying using a cold gun, brushing, or rolling.

20. The method of claim 18, wherein the ceramic nanoparticles comprise alumina, titania, ceria, zirconia, yttria, silica, chromia, or a combination comprising at least one of the foregoing compounds.

21. The method of claim 18, wherein the ceramic nanoparticles have a dimension of about 1 nanometer to about 5000 nanometers.

22. The method of claim 18, wherein the ceramic nanoparticles are agglomerated together to form a plurality of microparticles.

23. The method of claim 18, wherein the coating composition further comprises an organic polymer, an inorganic polymer, or a combination comprising at least one of the foregoing polymers.

24. The method of claim 23, further comprising curing the organic polymer or the inorganic polymer.

25. The method of claim 18, wherein the coating composition further comprises a liquid in which the ceramic nanoparticles are dispersed and a polymer additive.

26. The method of claim 18, wherein the coating composition further comprises a silicone polymer and a crosslinking agent.

27. The method of claim 18, wherein the coating composition further comprises polydimethylsiloxane, multialkyloxysilane, 1,3-divinyltetramethyl-disiloxane, vinyltrialkyloxysilane, or a combination comprising at least one of the foregoing compounds.

28. The method of claim 27, further comprising exposing the coating composition to sunlight to crosslink the polydimethylsiloxane (PDMS) and copolymerize the PMDS with the vinyltrialkyloxysilane.

29. A method of making a coating composition, comprising: combining ceramic nanoparticles with a polymer additive.

30. The method of claim 29, further comprising dispersing the ceramic nanoparticles and the polymer additive in a liquid to form a slurry.

31. The method of claim 29, wherein the polymer additive is a binder in which the ceramic nanoparticles are dispersed.

32. The method of claim 30, further comprising spray drying or granulizing the slurry.

33. The method of claim 29, wherein the ceramic nanoparticles comprise alumina, titania, ceria, zirconia, yttria, silica, chromia, or a combination comprising at least one of the foregoing compounds.

34. The method of claim 29, wherein the polymer additive comprises an organic polymer, an inorganic polymer, or a combination comprising at least one of the foregoing polymers.
